(19) United States
(12) Patent Application Publication
(10) Pub. No.: US 2022/0042889 A1
(43) Pub. Date: Feb. 10, 2022

(54) Structural Fatigue Strength Design Method Based on Intensity Field

(71) Applicant: UNIVERSITY OF SHANGHAI FOR SCIENCE AND TECHNOLOGY, SHANGHAI (CN)

(72) Inventor: Xi LU, SHANGHAI (CN)

(73) Assignee: UNIVERSITY OF SHANGHAI FOR SCIENCE AND TECHNOLOGY, SHANGHAI (CN)

(21) Appl. No.: 16/964,580

(22) PCT Filed: Mar. 13, 2020
(86) PCT No.: PCT/CN2020/079154

§ 371 Date: Jul. 23, 2020

(30) Foreign Application Priority Data
Jul. 11, 2019 (CN) 201910623543.1

(51) Int. Cl. G01N 3/06; G01N 3/08

(52) U.S. Cl. CPC G01N 3/06; G01N 3/08

(57) ABSTRACT

The invention provides a structural fatigue strength design method based on an intensity field, aiming at the phenomenon that the stress field is mismatched with the overall strength in the existing structural fatigue strength design process according to the overall strength viewpoint. The invention takes the fatigue strength of mechanical structures and parts as field treatment, and organically matches a structural stress field and a fatigue intensity field, wherein an ideal fatigue intensity field distribution of a dangerous section of the structure is determined according to the maximum stress amplitude distribution of the dangerous section of the structure; the actual fatigue intensity field of the dangerous section of the structure is designed by combining materials and heat treatment with cold working strengthening-residual stress field; and by using the full-field stress-strength interference model, the fatigue strength design level of the dangerous section of the structure can be quantitatively evaluated.

### TECHNICAL FIELD

The invention relates to the field of structural fatigue strength design in mechanical design, which is suitable for the fatigue strength design of mechanical structures and parts such as ferrous metals and nonferrous metals.

### Background

The existing fatigue strength design of mechanical structures and parts, whether limited service life design or unlimited service life design, treats the strength of mechanical structures and parts as a whole in the aspect of fatigue strength treatment. Therefore, the existing method considers that the fatigue strength of mechanical structures and parts is uniform inside and outside without difference. This contradicts that the mechanical structures and parts can be changed by surface heat treatment and work hardening to improve the surface strength and hardness thereof. The stress of the structure is the concept of the field and the local, and the fatigue load amplitude distribution of the dangerous section of the mechanical structures and parts in the full-field can be accurately solved through the material mechanics or the finite element method. In addition to bearing simple tensile and compressive fatigue loads, mechanical structures and parts have different stress amplitudes at different locations of structural dangerous sections. The existing fatigue strength design only considers the relationship between the maximum stress amplitude of the dangerous section and the overall fatigue strength, and compares the maximum stress of the dangerous point with the overall strength. Therefore, the existing mechanical structures and parts design method based on the overall strength cannot avoid the local strength excess of the dangerous section and thus cannot further provide the quantitative matching of materials, heat treatment and residual compressive stress influencing the fatigue strength of the dangerous section, and the design method lacks the theoretical and technical basis of the quantitative matching of design and manufacture. According to the concept of the intensity field provided by the invention, the structural fatigue strength design based on the intensity field is realized, and the maximum fatigue stress amplitude under the limit load and the stress distribution thereof in the gradient direction are converted into the distribution of an ideal fatigue intensity field, and then the fatigue strength design is carried out by quantitatively matching materials, heat treatment and residual compressive stress of dangerous section fatigue strength by taking the ideal fatigue intensity field as a target.

### SUMMARY OF THE INVENTION

The technical problem to be solved by the present invention is that the existing fatigue strength design process of a structure according to the overall strength viewpoint has the phenomenon that the stress field and the overall strength are mismatched.

In order to solve the technical problem, the technical scheme of the invention provides a structural fatigue strength design method based on an intensity field, which is characterized in that the fatigue strength of mechanical structures and parts is treated as a field, and the structural stress field and the structural fatigue intensity field are organically matched, comprising:

Step 1, determining the maximum stress amplitude and gradient distribution of the stress amplitude of a dangerous section of the structure with a fatigue strength to be designed under a given maximum fatigue load amplitude;

Step 2, according to the maximum stress amplitude and the gradient distribution of the stress amplitude of the dangerous section, carrying out ideal fatigue strength distribution design of the structure, wherein the ideal fatigue strength distribution requirement of the structure is that the strength of any point is not excessive and the strength requirement is met; and according to the theory of stress-strength interference, the ideal strength of any point of the dangerous section of the structure is designed as the fatigue stress amplitude of the point multiplied by a safety factor;

Step 3, matching materials and heat treatment to meet a static strength requirement and carrying out structural fatigue strength distribution design on the dangerous section, comprising the following steps of:

matching the fatigue strength of the dangerous section of the structure with the requirements of materials and heat treatment so that the dangerous section of the structure meets the design requirements of static strength distribution, and the structural fatigue strength distribution design of the dangerous section being carried out by using the transformation relationship between hardness-tensile strength-fatigue strength and combining the lowest hardness distribution curve and the highest hardness distribution curve of the material end quenching so that the designed structural fatigue strength distribution is intersected with the ideal fatigue strength distribution or tangent to the ideal fatigue strength distribution from inside;

Step 4, carrying out the actual fatigue strength distribution design of the dangerous section by combining a fatigue crack initiation requirement and a residual compressive stress distribution, calculating the quantitative influence of the residual compressive stress on the fatigue strength by taking the residual compressive stress as an average stress, and enabling the final design of the actual fatigue strength distribution to meet the requirement that the actual fatigue strength distribution curve intersects with an ideal fatigue intensity field distribution curve on the surface or is tangent to the ideal fatigue intensity field distribution curve from inside by matching materials, heat treatment and residual compressive stress, wherein when the intersection point is on a subsurface, fatigue crack initiation occurs on the subsurface; and when the intersection point is on the surface, fatigue crack initiation occurs on the surface so that the fatigue crack initiation position of the structure is designed by matching materials, heat treatment and residual compressive stress; and

Step 5, applying a full-field stress-strength interference model and putting the fatigue stress amplitude, the ideal fatigue strength, and the actual fatigue strength distribution in the same coordinate system to carry out a quantitative evaluation on the full-field fatigue strength design of the structure.

Preferably, in step 1, the dangerous position of the structure to be designed for fatigue strength is determined by material mechanics or finite element method calculation, and the maximum stress amplitude and the gradient distribution of the stress amplitude of the dangerous section at the dangerous position are determined.

Preferably, in step 2, when the ideal fatigue strength distribution of the structure design is carried out, the ideal fatigue intensity field distribution of the structure is determined according to the maximum stress amplitude and the gradient distribution of the stress amplitude of the dangerous section. The strength is greater than the stress according to the stress-strength interference theory, and the ratio of the ideal fatigue strength of any point on the dangerous section of the structure to the fatigue stress amplitude of the point is a constant greater than 1, and the constant is a safety factor. The ideal fatigue strength distribution on the dangerous section of the structure has no strength excess, and the strength utilization rate reaches the maximum.

Preferably, in step 5, when the ideal fatigue strength distribution and the actual fatigue intensity field distribution intersect on the surface, the strength excess of the subsurface and the core is quantitatively evaluated. When the ideal fatigue intensity field distribution and the actual fatigue strength distribution intersect at the subsurface, the strength excess of the surface and the core is quantitatively evaluated.

Preferably, in step 5, if the designed actual local fatigue strength is excessive, materials, heat treatment, and residual compressive stress distribution can be reasonably matched to reduce the local fatigue strength excess.

Compared with the traditional fatigue strength design method based on the overall strength, according to the present invention, local strength matching can be actively carried out on the material to solve the problem of local strength excess caused by unmatched local strength and stress led by original design according to the overall strength viewpoint. And material heat treatment and residual stress related to the mechanical structure design and manufacturing process are designed and manufactured quantitatively matched.

### BRIEF DESCRIPTION OF THE DRAWINGS

FIG. 1 is a flow chart illustrating an implementation of the present invention;

FIG. 2 shows fatigue tensile stress amplitude and ideal fatigue strength distribution;

FIG. 3 is a preliminary design of the structural fatigue strength distribution of a dangerous section;

FIG. 4 shows the distribution of residual compressive stress along with the depth;

FIG. 5 is a final design of the actual fatigue strength distribution of a dangerous section; and

FIG. 6 is a full-field evaluation of the structural fatigue strength.

### DETAILED DESCRIPTION OF THE PREFERRED EMBODIMENTS

The invention will be further elucidated with reference to the drawings. It should be understood that these embodiments are merely illustrative of the invention and are not intended to limit the scope of the invention. In addition, it will be understood that various changes and modifications may be made by those skilled in the art in light of the teachings of this invention, and equivalents may be resorted to, falls within the scope of the appended claims.

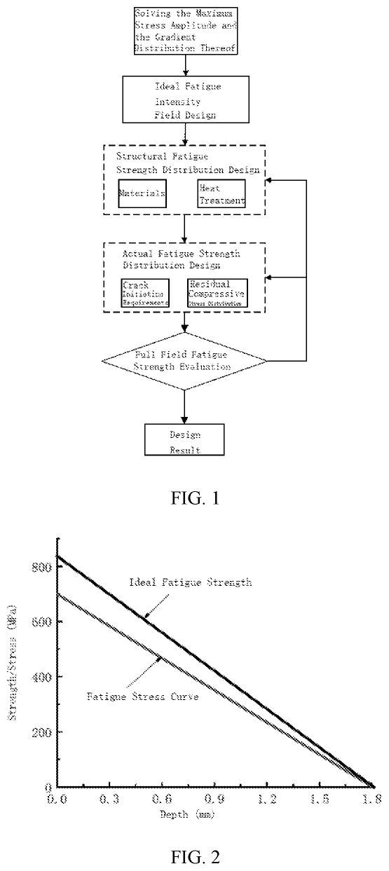

This embodiment further illustrates the present invention with a single tooth bending infinite fatigue strength design of a spur gear as an example. The material of the spur gear is 16 MnCr 5 steel, and the modulus of the gear is 2.3, and the number of the teeth is 20, and the pressure angle is 17° 30′, and the tooth root height is 2.875 mm, and the tooth thickness is 3.611 mm, and the tooth width is 11.25 mm. The heat treatment is in the form of carburizing and quenching, with the surface hardness being 59-63 HRC, the core hardness being 36-47 HRC, and the depth of the hardened layer being more than 0.70 mm. The surface of the gear is finally subjected to strong shot peening treatment and the maximum residual compressive stress is not less than 1000 MPa. The design requirement of single tooth bending fatigue strength is that cracks are initiated on the subsurface. The implementation flow chart of the invention is shown in FIG. 1 and comprises the following steps.

1) The maximum stress amplitude and gradient distribution of the dangerous section is determined under the given maximum fatigue load amplitude.

Under the given maximum fatigue load amplitude, the dangerous position of the structure, the maximum stress amplitude of the dangerous section and the gradient distribution of the stress amplitude of the maximum stress amplitude are calculated and determined by material mechanics or finite element method.

With regard to the single tooth bending of the spur gear of the present embodiment, the dangerous position of the single tooth bending is calculated at the root section of the gear by using the finite element analysis when the given fatigue load amplitude is 6 kN. The highest stress occurs at the root surface with a value of 705 MPa. The gradient direction of the highest stress is that the root points to the neutral layer along the load direction, and the fatigue tensile stress amplitude distribution at the dangerous position is shown in FIG. 2.

2) Ideal fatigue strength distribution design is carried out according to the highest stress amplitude of the dangerous section and the gradient distribution thereof.

An ideal fatigue strength distribution of a structure requires that the strength of any point is not excessive and meets the strength requirement and that the ratio of the ideal strength of any point of a dangerous section of the structure to the fatigue stress amplitude of the point is a constant. The ideal fatigue intensity field distribution of the structure can be determined according to the highest stress amplitude of the dangerous section and the gradient distribution thereof, and the strength is greater than the stress according to the stress-strength interference theory. The ratio of the ideal fatigue strength at any point on the dangerous section of the structure to the fatigue stress amplitude at that point is a constant greater than 1, which is a safety factor. The ideal fatigue strength distribution on the dangerous section of the structure has no excessive strength, and the strength utilization rate reaches the maximum.

In this embodiment, according to the single tooth bending infinite fatigue strength design requirement of the spur gear, the ideal fatigue strength is designed such that the ideal fatigue strength at any point of the dangerous section of the structure is larger than the limit stress amplitude at that point, and the ratio of the ideal fatigue strength to the limit stress amplitude is a constant, which is a safety factor and related to factors such as discrete load, material properties and the like. The safety factor in this embodiment is taken to be 1.2 and the ideal fatigue strength of the dangerous section is distributed along with the depth as shown in FIG. 2.

3) Materials and heat treatment are matched to meet the requirement of static strength, and structural fatigue strength distribution design of dangerous sections is carried out.

In addition to targeting the ideal fatigue strength distribution, the dangerous section fatigue strength should be matched with the materials and heat treatment requirements, so that the dangerous section of the structure can meet the design requirements of static strength distribution. Using the transformation relationship between hardness-tensile strength-fatigue strength, and combining with material end quenching the lowest and highest hardness distribution curves, the structural fatigue strength distribution design of a dangerous section is designed. The designed structural fatigue strength distribution is intersected with the ideal fatigue strength distribution on the surface or tangent to the ideal fatigue strength distribution from inside so that the structure can be prevented from generating large-scale structure fatigue strength excess on the surface, the sub-surface or the core.

In the present embodiment, the static strength dangerous section and the fatigue strength dangerous section is the same, and the surface hardness is minimized to 59 HRC according to the static fracture stress of 2600 MPa using the transformation relationship between hardness-tensile strength-fatigue strength under the condition that the static strength distribution of the dangerous section is satisfied. The 16 MnCr 5 steel can be subjected to carburizing and quenching treatment with the surface hardness being 59-63 HRC, with the core hardness being 36-47 HRC and the depth of hardened layer being more than 0.70 mm which can meet the static strength requirement. According to the end quenching curve of 16MnCr 5 steel and the corresponding relationship between hardness-tensile strength-fatigue strength, the distribution curve of fatigue strength of the dangerous section along the depth determined by single tooth bending structure of the embodiment can be obtained. For this embodiment, the transformation relationship of hardness-tensile strength-fatigue strength is shown as formula (1):

σ_{-ld}=0.3σ_{b}=0.3×(0.0136H_{d}^{2.88}+698) (1)

In formula (1): σ_{-ld} is the symmetrical cyclic fatigue strength at the depth d of the dangerous section expressed in MPa; σ_{b} is the tensile strength of the material expressed in MPa; and H_{d} is the HRC hardness at the depth d of the dangerous section.

Using Equation (1), the lowest and highest curves of the fatigue strength determined by the single tooth bending structure of this embodiment can be obtained, as shown in FIG. 3.

4) According to the fatigue crack initiation requirement and the residual compressive stress distribution, the actual fatigue strength distribution design of the dangerous section is carried out.

For a structure mainly subject to bending stress fatigue, in the final design of actual fatigue strength of the dangerous section, the cold work strengthening-residual compressive stress distribution should be considered to improve the fatigue strength. The residual compressive stress has a great influence on the fatigue strength of dangerous section surface and subsurface within 0.2 mm of the structure, which can improve the fatigue strength of dangerous section surface and subsurface within 0.2 mm of the structure. Considering the effect of residual compressive stress, the residual compressive stress can be used as the average stress to calculate the quantitative effect of the residual compressive stress on the fatigue strength. By matching materials, heat treatment and residual compressive stress, the final design of the actual fatigue strength distribution meets the requirement that the actual fatigue strength distribution curve intersects with an ideal fatigue intensity field distribution curve on the surface or is tangent to the ideal fatigue intensity field distribution curve from inside. When the intersection point is on the subsurface, fatigue crack initiation occurs on the subsurface; and when the intersection point is on the surface, the fatigue crack initiation occurs on the surface, and the fatigue crack initiation position of the structure can be designed through matching materials, heat treatment and residual compressive stress.

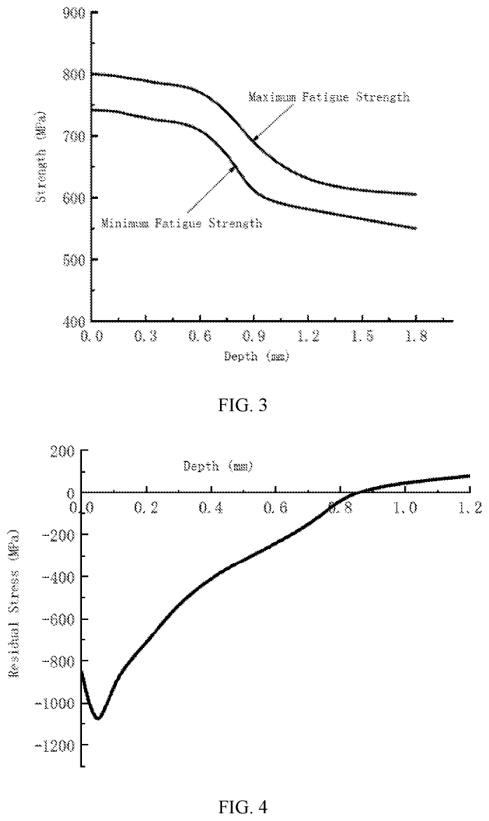

For the gear of this embodiment, the single tooth bending fatigue crack initiation requires that the fatigue strength of the subsurface of the dangerous section, i.e., the subsurface of the dangerous section, be the weakest relative to the fatigue stress amplitude. According to the strengthening characteristics of gear carburizing and quenching and forced shot peening cold working, the shot peening has residual compressive stress which has a great influence on fatigue strength at the dangerous section surface and sub-surface depth of 0.2 mm. In this case, the residual compressive stress on the surface is more than 800 MPa, and the residual compressive stress on the sub-surface around 0.05 mm is more than 1000 MPa at most and the residual compressive stress decreases sharply when the depth is more than 0.2 mm which has little influence on fatigue strength. The residual compressive stress of the dangerous section of the tooth root is distributed along with the depth as shown in FIG. 4.

Taking the residual stress as the average residual stress, this embodiment calculates the final fatigue strength with the residual stress considered according to Goodman. After considering the residual compressive stress, the fatigue strength of the single tooth bending is changed to σ₋ₗ_{^{d}}′ as follows:

σ₋ₗ_{^{d}}′=σ_{-ld}[1−(σ_{sd}/σ_{b})] (2)

In formula (2), σ₋ₗ_{^{d}}′ is the fatigue strength at the tooth root depth d after the residual stress is considered and is expressed in MPa; σ_{-ld} is the fatigue strength of the structure at the tooth root depth d expressed in MPa; and σ_{sd} is the stress distribution at the tooth root depth d expressed in MPa.

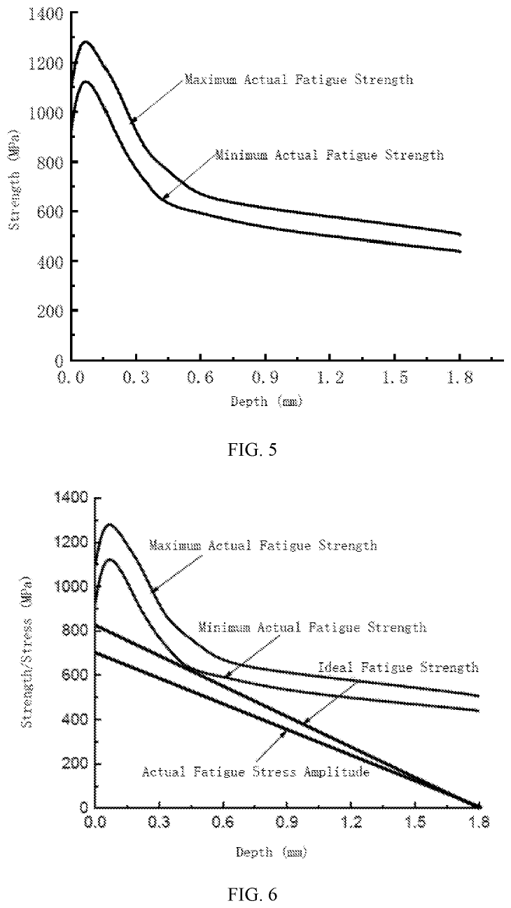

Using Equation (2), the lowest and highest curves of the actual fatigue strength of the single tooth bending of this embodiment can be obtained, as shown in FIG. 5.

5) The design of the full-field fatigue strength of the structure is quantitatively evaluated by using a full-field stress-strength interference model.

The fatigue stress amplitude, the ideal fatigue strength and the actual fatigue strength distribution of the dangerous section of the structure are placed in the same coordinate system, such that the full-field fatigue strength design of the structure can be evaluated. Fatigue strength design needs to ensure that the actual fatigue strength of any point of the dangerous section is greater than or equal to the ideal fatigue strength of the point. When the distribution of the ideal fatigue strength and the distribution of the actual fatigue intensity field are intersected on the surface, the strength excess of the subsurface and the core is quantitatively evaluated; and when the ideal fatigue intensity field distribution and the actual fatigue strength distribution intersect at the subsurface, the strength excess of the surface and core is quantitatively evaluated. If the actual local fatigue strength of the design is excessive, materials, heat treatment and residual compressive stress distribution can be reasonably matched to reduce the local fatigue strength excess.

For the present embodiment, the fatigue stress amplitude, the ideal fatigue strength, and the actual fatigue strength of the dangerous section of the structure are distributed in the same coordinate system, as shown in FIG. 6. It can be seen that the actual fatigue strength and the ideal fatigue strength intersect at the subsurface of 0.4 mm, where the actual fatigue strength is equal to the ideal fatigue strength, and there is no design excess, and crack initiation occurs there to meet the product design requirements. This embodiment evaluates the fatigue strength at other locations in the figure, i.e. the surface and around 1.8 mm of the neutral layer.

The actual bending fatigue strength of the surface is 920 MPa, and the design ideal bending fatigue strength is 846 MPa, and the actual bending fatigue stress amplitude is 703 MPa. If the ratio of the actual bending fatigue strength to the actual bending fatigue stress amplitude is 1.31, which is greater than the design safety factor 1.2 exceeding the safety factor 0.11, the fatigue strength is basically fully exerted.

The actual bending fatigue strength of the 1.8 mm surface of the neutral layer is 437 MPa. The amplitude of the designed ideal bending fatigue strength and the actual bending fatigue stress is 0, and the fatigue strength excess at this point is infinite, and the core fatigue strength excess can be reduced by using a hollow structure if the process conditions permit.

1. The invention relates to a structural fatigue strength design method based on an intensity field, characterized in that fatigue strength of mechanical structures and parts is treated as a field and a stress field and a fatigue intensity field of a structure are organically matched, comprising steps as follows:
step 1, determining the maximum stress amplitude and gradient distribution of the stress amplitude of a dangerous section of a structure with a fatigue strength to be designed under a given maximum fatigue load amplitude;
step 2, according to the maximum stress amplitude and the gradient distribution of the stress amplitude of the dangerous section, carrying out ideal fatigue strength distribution design of the structure, wherein the ideal fatigue strength distribution requirement of the structure is that the strength of any point is not excessive and the strength requirement is met; and according to the theory of stress-strength interference, the ideal strength of any point of the dangerous section of the structure is designed as the fatigue stress amplitude of the point multiplied by a safety factor;
Step 3, matching materials and heat treatment to meet a static strength requirement and carrying out structural fatigue strength distribution design on the dangerous section, comprising the following steps of:
matching the fatigue strength of the dangerous section of the structure with the requirements of materials and heat treatment so that the dangerous section of the structure meets the design requirements of static strength distribution, and the structural fatigue strength distribution design of the dangerous section being carried out by using the transformation relationship between hardness-tensile strength-fatigue strength and combining the lowest hardness distribution curve and the highest hardness distribution curve of the material end quenching so that the designed structural fatigue strength distribution is intersected with the ideal fatigue strength distribution or tangent to the ideal fatigue strength distribution from inside;
step 4, carrying out the actual fatigue strength distribution design of the dangerous section by combining a fatigue crack initiation requirement and a residual compressive stress distribution, calculating the quantitative influence of the residual compressive stress on the fatigue strength by taking the residual compressive stress as an average stress, and enabling the final design of the actual fatigue strength distribution to meet the requirement that the actual fatigue strength distribution curve intersects with an ideal fatigue intensity field distribution curve on the surface or is tangent to the ideal fatigue intensity field distribution curve from inside by matching materials, heat treatment and residual compressive stress, wherein when the intersection point is on a subsurface, fatigue crack initiation occurs on the subsurface; and when the intersection point is on the surface, fatigue crack initiation occurs on the surface so that the fatigue crack initiation position of the structure is designed by matching materials, heat treatment and residual compressive stress; and
step 5, applying a full-field stress-strength interference model and putting the fatigue stress amplitude, the ideal fatigue strength and the actual fatigue strength distribution in the same coordinate system to carry out a quantitative evaluation on the full-field fatigue strength design of the structure.

2. The structural fatigue strength design method based on an intensity field according to claim 1, characterized in that in step 1, a dangerous position of the structure to be designed for fatigue strength is determined by material mechanics or finite element method calculation, and the maximum stress amplitude of the dangerous section at the dangerous position and gradient distribution of the stress amplitude are determined.

3. The structural fatigue strength design method based on an intensity field according to claim 1, characterized in that in step 2 when the ideal fatigue strength distribution design of the structure is carried out, the ideal fatigue intensity field distribution of the structure is determined according to the maximum stress amplitude and the gradient distribution of the stress amplitude of the dangerous section, and the strength is greater than the stress according to the stress-strength interference theory, and the ratio of the ideal fatigue strength of any point on the dangerous section of the structure to the fatigue stress amplitude of the point is a constant larger than 1 with the constant being a safety factor, and the ideal fatigue strength distribution on the dangerous section of the structure does not have strength excess and the strength utilization rate reaches the maximum.

4. The structural fatigue strength design method based on an intensity field according to claim 1, characterized in that in step 5, when the ideal fatigue strength distribution and the actual fatigue intensity field distribution intersect at the surface, the strength excess of the subsurface and a core is quantitatively evaluated; and when the ideal fatigue intensity field distribution and the actual fatigue strength distribution intersect at the subsurface, the strength excess of the surface and the core is quantitatively evaluated.

5. The structural fatigue strength design method based on an intensity field according to claim 4, characterized in that in step 5, if the designed actual local fatigue strength is excessive, the local fatigue strength excess is reduced by reasonably matching materials, heat treatment and residual compressive stress distribution.
